(19) United States
(12) Patent Application Publication
(10) Pub. No.: US 2010/0240561 A1
(43) Pub. Date: Sep. 23, 2010

(54) Contact Lens-Treating Solution and Method for Treating a Contact Lens

(75) Inventors: Chih-Ta Lee, Taoyuan Hsien (TW); Wei-Chun Chang, Taoyuan Hsien (TW); Yi-Fang Shou, Taoyuan Hsien (TW); Ken-Yuan Chang, Taoyuan Hsien (TW)

Correspondence Address: STEPTOE & JOHNSON LLP, 1330 CONNECTICUT AVENUE, N.W., WASHINGTON, DC, 20036, US

(73) Assignee: FAR EASTERN TEXTILE LTD., Taipei-City (TW)

(21) Appl. No.: 12/562,428

(22) Filed: Sep. 18, 2009

(30) Foreign Application Priority Data
Mar. 23, 2009 (TW) 098109352

(51) Int. Cl. C11D 3/37

(52) U.S. Cl. 510/113

(57) ABSTRACT

A contact lens-treating solution contains polyelectrolyte complex particulates and an aqueous solution for dispersing the polyelectrolyte complex particulates. Each of the polyelectrolyte complex particulates is formed of a cationic polymer and an anionic polymer. The aqueous solution contains water and an additive including a surfactant, an antibacterial agent, a cleaning agent, a thickening agent, a chelating agent, and combinations thereof for cleaning or maintaining the contact lens. A method for treating a contact lens using a contact lens-treating solution containing water and polyelectrolyte complex particulates is also disclosed.

### CROSS-REFERENCE TO RELATED APPLICATION

This application claims priority of Taiwanese Application No. 098109352, filed on Mar. 23, 2009.

### BACKGROUND OF THE INVENTION

1. Field of the Invention

This invention relates to a contact lens-treating solution, more particularly to a contact lens-treating solution for removing positively charged deposits, such as proteins, lipids and calcium on the contact lens, and a method for treating the contact lens by using the contact lens-treating solution.

2. Description of the Related Art

Applying contact lens on the eyes may lead to deposit formation, such as proteins, lipids, calcium and dust, on the contact lenses. One of the major parts of proteins which has high ability to deposit on the contact lens is lysozyme that is difficult to be removed normally. The deposits may cause fast and easy bacterial growth, which can increase the chance of infection in the eyes or ophthalmology diseases during the use of the contact lens. As a result, finding out a way to remove lysozyme out of the contact lens is the most important technique in contact lens-treating solution field.

The conventional contact lens-treating solution normally contains surfactants, enzymes, oxidizing agents or other components as cleaning agents and also needs to work with shaking, stirring, rubbing treatments to increase ability in removal of lysozyme out of the surface of the contact lens. However, the current ways not only have disadvantages, such as taking long reaction time to remove the deposits, residuals on the lens, incompatibility of the components, but also are ineffective in removing lysozyme protein.

In addition, another conventional contact lens-treating solution contains inorganic particles performing physical procedures coping with shaking, stirring or rubbing action in virtue of collision to remove the deposits easily out of the surface of the contact lens. However, this type of contact lens-treating solution is suitable for hard contact lens only because inorganic particles which have high degree of hardness may cause damage of the surface of soft contact lens.

A current method in cleaning soft contact lens is immersing contact lens into the contact lens-treating solution for several hours after slightly washing the surface of contact lens with saline. However, it cannot effectively remove the deposit of lysozyme out of the surface of the contact lens.

Lysozyme exhibits a positively charged property when in contact with a solution having a pH value ranging from 6 to 8. Hence, removal of lysozyme can be enhanced by adding a negatively charged material into the treating solution.

U.S. Pat. No. 6,995,123 discloses an aqueous solution comprising water and an ionic dissociating compound that can interact with lysozyme. The compound has the following formula:

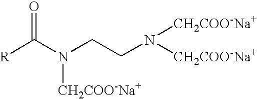

R is a straight or branched alkyl, or alkenyl group containing a total of from 8 to 18 carbon atoms. U.S. Pat. No. 5,648,074 discloses a composition comprising a liquid medium, a chlorine dioxide precursor, and a polyanionic component having multiple anionic charges to interact with lysozyme. U.S. Patent Application Publication No. 2004/0121924 discloses an aqueous composition comprising an anionic chitosan derivative, such as sulfuryl chitosan, phosphoryl chitosan, carboxymethyl chitosan, dicarboxymethyl chitosan, and succinyl chitosan.

However, enhancement in removal of lysozyme by the negatively charged materials disclosed in the above patents is poor. This may be attributed to the grounds that the negatively charged materials can only form into small aggregates, which have no concrete shape, in the treating solution, and that only a small amount of these small aggregates can be attached to lysozyme, which cannot produce a sufficient force by the flow of the cleaning solution under stirring to remove the lysozyme having a molecular weight of 14.4 kDa out of the surface of the contact lens. Hence, there is a need to search a negatively charged material that can form into large negatively charged particulates and permit attachment of a large amount of the large particulates to lysozyme so as to produce sufficient force by the flow of the cleaning solution to remove lysozyme from the contact lens.

### SUMMARY OF THE INVENTION

Therefore, an object of the present invention is to provide a contact lens-treating solution that can effectively remove positively charged deposits from a contact lens.

According to one aspect of this invention, there is provided a contact lens-treating solution comprising polyelectrolyte complex particulates, each of which is formed of a cationic polymer and an anionic polymer, and an aqueous solution for dispersing the polyelectrolyte complex particulates. The aqueous solution contains water and an additive selected from the group consisting of a surfactant, an antibacterial agent, a cleaning agent, a thickening agent, a chelating agent and combinations thereof for cleaning or maintaining the contact lens.

According to another aspect of this invention, there is provided a method for treating a contact lens comprising contacting a contact lens with a contact lens-treating solution containing water and polyelectrolyte complex particulates dispersed in the water. Each of the polyelectrolyte complex particulates is formed of a cationic polymer and an anionic polymer.

### BRIEF DESCRIPTION OF THE DRAWING

Other features and advantages of the present invention will become apparent in the following detailed description of the preferred embodiments of this invention, with reference to the accompanying drawing, in which:

FIG. 1 is a photograph illustrating the appearance of the polyelectrolyte complex particulates in the contact lens-treating solution of Example 1 of this invention.

### DETAILED DESCRIPTION OF THE PREFERRED EMBODIMENTS

The present invention is directed to a method for treating a contact lens. The method includes the step of contacting a contact lens with a contact lens-treating solution containing water and polyelectrolyte complex particulates dispersed in the water. Each of the polyelectrolyte complex particulates is formed of a cationic polymer and an anionic polymer, which can permit formation of large negatively charged particulates and attachment of a large amount of the large particulates to lysozyme so as to produce sufficient force by the flow of the cleaning solution to remove lysozyme from the contact lens.

The contact of the contact lens with the contact lens-treating solution can be effected by virtue of, e.g., immersion of the contact lens in the contact lens-treating solution. In addition, ultrasonic vibration, shaking, stirring, rubbing, etc., can be used to assist in removal of lysozyme out of the surface of the contact lens.

The polyelectrolyte complex particulates exhibit a negative zeta potential. Preferably, the zeta potential ranges from −80 mV to −28 mV in the contact lens-treating solution, which has a pH value ranging from 6 to 8; and more preferably, from −67 mV to −30 mV. When the zeta potential is below −80 mV, the polyelectrolyte complex particulates are difficult to be formed. When the zeta potential is above −28 mV, the polyelectrolyte complex particulates tend to aggregate. In the preferred embodiments of this invention, the zeta potential ranges from −53 mV to −28 mV.

Preferably, the contact lens-treating solution has a pH value ranging from 6 to 8; and more preferably, from 6 to 7.5. In the preferred embodiments of this invention, the pH value ranges from 6.89 to 7.01.

Preferably, the concentration of the polyelectrolyte complex particulates in the contact lens-treating solution ranges from 1×10⁻⁶ g/mL to 1×10⁻² g/mL; and more preferably, from 5×10⁻⁶ g/mL to 1×10⁻³ g/mL. In the preferred embodiments of this invention, the concentration of the polyelectrolyte complex particulates ranges from 1×10⁻⁴ g/mL to 1.2×10⁻³ g/mL.

Examples of the cationic polymer include chitosan, gelatin, polylysine, polyethyleneimine, polyacrylamide, and combinations thereof. Preferably, the cationic polymer is chitosan, gelatin, polylysine or combinations thereof. In the preferred embodiments of this invention, the cationic polymer is chitosan.

Examples of the anionic polymer include poly-γ-glutamic acid (γ-PGA), alginate, poly-L-glutamic acid, poly-L-glutamate, hyaluronic acid, alginic acid, chondroitin sulfate, dextran sulfate, pectin, polyaspartic acid, polyacrylic acid, and combinations thereof. Preferably, the anionic polymer is γ-PGA, alginate, hyaluronic acid, alginic acid, pectin, or combinations thereof. In the preferred embodiments of this invention, the anionic polymer is γ-PGA.

The weight-average molecular weight of each of the cationic polymer and the anionic polymer is within a range sufficient to form a stable and large polyelectrolyte complex particulate in order to effectively remove the lysozyme deposit out of the contact lens. Preferably, each of the cationic polymer and the anionic polymer has a weight-average molecular weight ranging from 80 kDa to 2000 kDa. More preferably, the cationic polymer has a weight-average molecular weight ranging from 100 kDa to 1000 kDa; and most preferably, from 110 kDa to 750 kDa. More preferably, the anionic polymer has a weight-average molecular weight ranging from 500 kDa to 1500 kDa; and most preferably, from 900 kDa to 1200 kDa. In the preferred embodiments of this invention, the weight-average molecular weight of the cationic polymer is 120 kDa, and the weight-average molecular weight of the anionic polymer is 1000 kDa.

The contact lens-treating solution is prepared by adding a first aqueous solution containing the cationic polymer into a second aqueous solution containing the anionic polymer so as to form the polyelectrolyte complex particulates, followed by dispersing the polyelectrolyte complex particulates in an aqueous solution. Preferably, the first aqueous solution is added dropwisely into the second aqueous solution. As such, due to the attraction between the cationic functional group and the anionic functional group, each droplet of the cationic polymer can be surrounded by tiny droplets of the anionic polymer so as to form the polyelectrolyte complex particulates. Each of the polyelectrolyte complex particulates thus formed is considered as having a structure that includes a positively charged core of the cationic polymer and a plurality of negatively charged particulates of the anionic polymer those are surrounding and bonded to the core of the cationic polymer through charge-and-charge interaction.

Preferably, the second aqueous solution is under stirring during addition of the first aqueous solution therein. Preferably, the stirring rate ranges from 100 rpm to 10000 rpm; more preferably, from 200 rpm to 8000 rpm; and most preferably, from 250 rpm to 6000 rpm. In the preferred embodiments of this invention, the stirring rate ranges from 450 rpm to 4000 rpm.

Preferably, the volume of each droplet of the first aqueous solution to be dropwisely added into the second aqueous solution ranges from 50 μL to 2000 μL; more preferably, from 100 μL to 1500 μL; and most preferably, from 250 μL to 1200 μL. In the preferred embodiments of this invention, the volume of each droplet of the first aqueous solution is 500 μL, the total volume of the first aqueous solution is 5 mL, and the total volume of the second aqueous solution is 45 mL.

For forming stable polyelectrolyte complex particulates, the zeta potential and the concentration of each of the cationic and anionic polymers, the concentration of the cationic functional groups of the cationic polymer in the first aqueous solution [C⁺], the concentration of the anionic functional groups of the anionic polymer in the second aqueous solution [A⁻], and pH values of the first and second aqueous solutions should be also considered.

Preferably, in the first aqueous solution, the cationic polymer has a zeta potential ranging from 0.1 mV to 85 mV; more preferably, from 30 mV to 80 mV; and most preferably, from 40 mV to 80 mV. In the preferred embodiments of this invention, the zeta potential of the cationic polymer ranges from 54.49 mV to 79.87 mV.

Preferably, in the second aqueous solution, the anionic polymer has a zeta potential ranging from −85 mV to −30 mV; more preferably, from −80 mV to −30 mV; and most preferably, from −80 mV to −40 mV. In the preferred embodiments of this invention, the zeta potential of the anionic polymer ranges from −76.82 mV to −60.93 mV.

Preferably, based on the total weight of the first aqueous solution, the concentration of the cationic polymer ranges from 0.0001 wt % to 3 wt %; more preferably, from 0.01 wt % to 2 wt %; and most preferably, from 0.1 wt % to 1 wt %.

Preferably, based on the total weight of the second aqueous solution, the concentration of the anionic polymer ranges from 0.0001 wt % to 5 wt %; more preferably, from 0.01 wt % to 3 wt %; and most preferably, from 0.1 wt % to 1 wt %.

Preferably, the first aqueous solution has a pH value ranging from 4 to 8; and more preferably, from 4 to 5. Preferably, the second aqueous solution has a pH value ranging from 6 to 8; and more preferably, from 6.5 to 7. In the preferred embodiments of this invention, the first aqueous solution has a pH value ranging from 4.00 to 4.18, and the second aqueous solution has a pH value ranging from 6.12 to 6.89.

The concentration of the cationic functional groups of the cationic polymer in the first aqueous solution ([C⁺]) and the concentration of the anionic functional groups of the anionic polymer in the second aqueous solution ([A⁻]) are calculated according to the following two formulas, respectively:

[C⁺]=[(W₁×C₁×i₁)/(M₁)]/V₁

[A⁻]=[(W₂×C₂×i₂)/(M₂)]/V₂

W₁ and W₂ represent the total weight of the first aqueous solution and the total weight of the second aqueous solution, respectively; C₁ and C₂ represent the weight percentage of the cationic polymer in the first aqueous solution and the weight percentage of the anionic polymer in the second aqueous solution, respectively; i₁ and i₂ represent the theoretical number of the cationic functional groups dissociated from each repeating unit of the cationic polymer and the theoretical number of the anionic functional groups dissociated from each repeating unit of the anionic polymer, respectively; M₁ and M₂ represent the molecular weight of the cationic polymer and the molecular weight of the anionic polymer, respectively; and V₁ and V₂ represent the volume of the first aqueous solution and the volume of the second aqueous solution, respectively. It is noted that i₁ and i₂ vary with the pH value of the first aqueous solution and the pH value of the second aqueous solution, respectively.

Preferably, [A⁻]/[C⁺] ranges from 1.176 to 1000; more preferably, from 1.538 to 100; and most preferably, from 2 to 20. In the preferred embodiments of this invention, [A⁻]/[C⁺] ranges from 2.37 to 11.90.

The shape of each of the polyelectrolyte complex particulates formed according to the method of this invention is substantially spherical.

Preferably, the polyelectrolyte complex particulates have an average particle size ranging from 200 nm to 5000 nm; more preferably, from 220 nm to 4500 nm; and most preferably, from 220 nm to 4000 nm. In the preferred embodiments of this invention, the polyelectrolyte complex particulates have an average particle size ranging from 227 nm to 4182 nm.

The contact lens-treating solution may further contain an additive, e.g., a surfactant, an antibacterial agent, a cleaning agent, a thickening agent, a chelating agent, and combinations thereof. The aqueous solution further contains an enzyme for digesting proteins, such as papain. These additives can provide different effects or functions, such as removing deposits other than lysozyme and preventing residual additive(s) from remaining on the contact lens after cleaning. Hence, one or more of these additives can be included in the contact lens-treating solution according to the actual requirements.

Examples of the surfactant include polysorbates (such as TWEEN 20), 4-(1,1,3,3-tetramethylbutyl)phenol/poly(oxyethylene) polymer, poly(oxyethylene)-poly(oxypropylene) block copolymer, glycolic ester of fatty acids, Poloxamer 108, Poloxamer 237, Poloxamer 238, Poloxamer 288, Poloxamer 407, and combinations thereof. Preferably, the amount of the surfactant ranges from 0.005 wt % to 1 wt % based on the total weight of the aqueous solution.

Examples of the antibacterial agent include quaternary ammonium salt, poly(dimethylimino-2-butene-1,4-diyl) chloride, polyquaternium-1, benzalkonium halides, biguanides, salts of alexidine, salts of chlorhexidine, hexamethylenebiguanide polymer (PHMB), polyaminopropyl biguanide (PAPB), and combinations thereof. Preferably, the amount of the antibacterial agent ranges from 0.00001 wt % to 2.5 wt % based on the total weight of the aqueous solution.

Examples of the thickening agent include cellulose derivates, guar gum, gum tragacanth, hydroxypropyl cellulose, hydroxypropylmethyl cellulose, carboxymethyl cellulose, methyl cellulose, hydroxyethyl cellulose, and combinations thereof. Preferably, the amount of the thickening agent ranges from 0.005 wt % to 5 wt % based on the total weight of the aqueous solution.

Examples of the chelating agent include nitrilotriacetic acid, diethylenetriamine pentaacetic acid, hydroxyethylethylene diaminetriacetic acid, 1,2-diaminocyclohexane, tetraacetic acid, hydroxyethylaminodiacetic acid, polyphosphates, citric acid, ethylenediamine tetraacetic acid (EDTA), salts of EDTA (such as Na₂EDTA), and combinations thereof. Preferably, the amount of the chelating agent ranges from 0.001 wt % to 2 wt % based on the total weight of the aqueous solution.

The following examples and comparative example are provided to illustrate the merits of the preferred embodiments of the invention, and should not be construed as limiting the scope of the invention.

### EXAMPLE

### Example 1

### 1. Preparation of the Polyelectrolyte Complex Particulates

5 mL of 0.5 wt % chitosan aqueous solution having an average zeta potential of 57.06 mV was prepared by dissolving chitosan (purchased from Sigma Co.) with a weight-average molecular weight of 120 kDa in water. 45 mL of 0.1 wt % γ-PGA aqueous solution having an average zeta potential of −76.82 mV was prepared by dissolving γ-PGA (purchased from VEDAN ENTERPRISE CORP.) with a weight-average molecular weight of 1000 kDa in water. The chitosan aqueous solution was added dropwisely into the γ-PGA aqueous solution with a droplet size of 500 μL under a stirring rate of 3000 rpm so as to obtain a mixture containing polyelectrolyte complex particulates. The pH value of the mixture, the particle size, polydispersity index (PDI), and the concentration of the polyelectrolyte complex particulates in the mixture was measured (see Table 1).

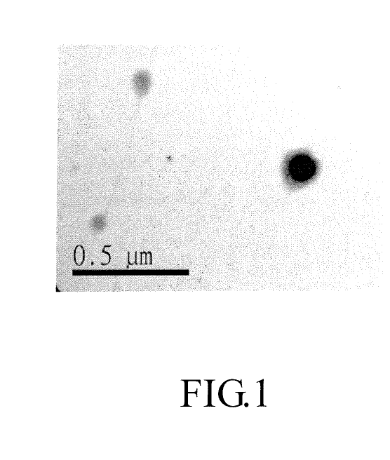

The mixture was then centrifuged, followed by decanting the supernatant so as to obtain the polyelectrolyte complex particulates. FIG. 1 shows the appearance of the polyelectrolyte complex particulates thus formed.

### 2. Preparation of the Contact Lens-Treating Solution

The polyelectrolyte complex particulates formed above were dispersed in an aqueous buffer solution containing 50 mL of deionized water and 0.25 g of disodium hydrogen phosphate under stirring so as to obtain a contact lens-treating solution of Example 1.

The cleaning ability of the contact lens-treating solution thus formed was tested as follows. Clean contact lenses were disposed into 1 mg/mL of a lysozyme solution, followed by shaking the lysozyme solution for 24 hrs. The contact lenses stained with lysozyme were then disposed in the contact lens-treating solution of Example 1 under stirring at 100 rpm for 6 hrs. The concentration of lysozyme in the contact lens-treating solution was measured according to the ELISA method. The cleaning ability is defined as an adsorbed amount of lysozyme in milligram per gram of the polyelectrolyte complex particulates. The cleaning test results of Example 1 are shown in Table 2.

### Example 2˜9

The procedures in preparing the polyelectrolyte complex particulates and the contact lens-treating solutions of each of Examples 2-9 are similar to those of Example 1, except that in Examples 2-9, some of the conditions are different from those of Example 1 (see Table 1). The cleaning test results of Examples 2˜9 are shown in Table 2.

TABLE 1

| Example Nos. | | | | | | | | |
|---|---|---|---|---|---|---|---|---|
| 1 | 2 | 3 | 4 | 5 | 6 | 7 | 8 | 9 |

| | | | | | | |
|---|---|---|---|---|---|---|
| Chitosan | Conc. (%) | 0.5 | 0.5 | 1.0 | 0.1 | 0.5 |
| aqueous | [C⁺] | 1.37 | 1.37 | 2.75 | 0.28 | 1.37 |
| solution | (10⁻⁴M) | | | | | |
| | pH | 4.02 | 4.02 | 4.00 | 4.18 | 4.02 |
| | Zeta | 57.06 | 57.06 | 54.49 | 79.87 | 57.06 |
| | potential | | | | | |
| | (mV) | | | | | |
| γ-PGA | Conc. (%) | 0.1 | 0.2 | 0.5 | 0.2 | 0.5 |
| aqueous | [A⁻] | 3.26 | 6.52 | 16.3 | 6.52 | 16.3 |
| solution | (10⁻⁴M) | | | | | |
| | pH | 6.89 | 6.60 | 6.12 | 6.60 | 6.12 |
| | Zeta | −76.82 | −60.93 | −70.41 | −60.93 | −70.41 |
| | potential | | | | | |
| | (mV) | | | | | |

| | | | | | | | | | |
|---|---|---|---|---|---|---|---|---|---|
| Stirring rate | 3 | 3 | 3 | 3 | 0.45 | 1 | 2 | 3 | 4 |
| (×1000 rpm) | | | | | | | | | |

| | | | | | |
|---|---|---|---|---|---|
| [A⁻]/[C⁺] | 2.38 | 4.76 | 5.93 | 2.37 | 11.90 |
| pH of the mixture | 4.70 ± 0.03 | 4.95 ± 0.02 | 4.86 ± 0.04 | 5.76 ± 0.02 | 5.16 ± 0.03 |

TABLE 2

| | | Polyelectrolyte complex | | | | Contact lens-treating | | |
|---|---|---|---|---|---|---|---|---|
| | | particulates | | | | solution | | |
| | | | Average | | Zeta | | Particulate | Cleaning |
| | | Weight | particle | | potential | | concentration | ability |
| | | (g) | size(nm) | PDI | (mV) | pH | (10⁻⁴ g/ml) | (mg/g) |
| Example Nos. | 1 | 0.02 | 243 ± 16 | 0.20 ± 0.03 | −35 ± 4 | 6.9 ± 0.01 | 4 | 938 |
| | 2 | 0.03 | 805 ± 9 | 0.21 ± 0.03 | −47 ± 3 | 7 ± 0.02 | 6 | 806 |
| | 3 | 0.06 | 1636 ± 33 | 0.23 ± 0.04 | −48 ± 3 | 6.93 ± 0.01 | 12 | 577 |
| | 4 | 0.005 | 297 ± 138 | 0.26 ± 0.03 | −37 ± 9 | 7 ± 0.01 | 1 | 923 |
| | 5 | 0.0259 | 3944 ± 238 | 0.18 ± 0.04 | −42 ± 3 | 7 ± 0.01 | 5.18 | 312 |
| | 6 | 0.0288 | 3246 ± 254 | 0.28 ± 0.03 | −45 ± 4 | 7 ± 0.01 | 5.76 | 375 |
| | 7 | 0.0255 | 2623 ± 138 | 0.18 ± 0.02 | −46 ± 2 | 7 ± 0.01 | 5.1 | 412 |
| | 8 | 0.0267 | 1827 ± 113 | 0.28 ± 0.02 | −50 ± 3 | 7 ± 0.01 | 5.34 | 571 |
| | 9 | 0.0268 | 1522 ± 94 | 0.23 ± 0.03 | −49 ± 4 | 7 ± 0.01 | 5.36 | 714 |

As shown in Table 2, the polyelectrolyte complex particulates prepared in Examples 1˜9 have a negative average zeta potential ranging from −28 mV to −53 mV, a weight ranging from 0.005 g to 0.06 g, and an average particle size ranging from 159 nm to 4182 nm. FIG. 1 shows that the polyelectrolyte complex particulates thus formed are generally spherical in shape.

The cleaning ability of the contact lens-treating solutions of Examples 1˜9 ranges from 312 mg/g to 938 mg/g.

### Example 10

The procedure of preparing the contact lens-treating solution of Example 10 is similar to that of Example 9, except that, in Example 10, the aqueous buffer solution for dispersion of the polyelectrolyte complex particulates contains 5 g of disodium hydrogen phosphate (purchased from ECHO CHEMICAL Co. Ltd., model name: 7982-1250), 5.5 g of Na₂EDTA (purchased from ECHO CHEMICAL Co. Ltd., model name: AC0965), 15 g of non-ionic surfactant (purchased from Sigma Co., model name: P2443), 50 anson units of papain (purchased from Sigma Co., model name: P3375), and deionized water, and has a total volume of 1 L.

The cleaning test results are shown in Table 3.

### Comparative Example

50 mL of the aqueous buffer solution prepared in Example 10 was used as the contact lens-treating solution in the Comparative Example. The cleaning test results of the Comparative Example are shown in Table 3.

TABLE 3

| | | | Comparative |
|---|---|---|---|
| | | Example 10 | Example |
| Component | Particulate | 5.36 | 0 |
| | concentration | | |
| | (10⁻⁴ g/ml) | | |
| | Content of the | 50 | 50 |
| | buffer solution | | |
| | (mL) | | |

| | | |
|---|---|---|
| pH | 6.95 | 7.02 |
| Cleaning ability (mg/mL)* | 0.3123 | 0.208 |
| Cleaning ability (mg/g) | 582.9493 | — |

*The cleaning ability represents the lysozyme concentration in the contact lens-treating solution (mg/mL)

As shown in Table 3, the contact lens-treating solution of Example 10 has a better cleaning ability in removing lysozyme than the Comparative Example.

In conclusion, with the inclusion of the polyelectrolyte complex particulates formed of a cationic polymer and an anionic polymer in the contact lens-treating solution of this invention, removal of lysozyme deposit from the contact lens can be considerably enhanced.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A contact lens-treating solution comprising:
polyelectrolyte complex particulates, each of which is formed of a cationic polymer and an anionic polymer; and
an aqueous solution for dispersing said polyelectrolyte complex particulates, said aqueous solution containing water and an additive selected from the group consisting of a surfactant, an antibacterial agent, a cleaning agent, a thickening agent, a chelating agent, and combinations thereof for cleaning or maintaining the contact lens.

2. The contact lens-treating solution of claim 1, wherein each of said polyelectrolyte complex particulates exhibits a zeta potential ranging from −80 mV to −28 mV in said contact lens-treating solution which has a pH value ranging from 6 to 8.

3. The contact lens-treating solution of claim 1, wherein said cationic polymer is selected from the group consisting of chitosan, gelatin, polylysine, polyethyleneimine, polyacrylamide and combinations thereof.

4. The contact lens-treating solution of claim 1, wherein said anionic polymer is selected from the group consisting of poly-γ-glutamic acid, alginate, poly-L-glutamic acid, poly-L-glutamate, hyaluronic acid, alginic acid, chondroitin sulfate, dextran sulfate, pectin, polyaspartic acid, polyacrylic acid and combinations thereof.

5. The contact lens-treating solution of claim 1, wherein each of said cationic polymer and said anionic polymer has a weight-average molecular weight ranging from 80 kDa to 2000 kDa.

6. The contact lens-treating solution of claim 1, wherein each of said polyelectrolyte complex particulates is spherical in shape.

7. The contact lens-treating solution of claim 6, wherein said polyelectrolyte complex particulates have a particle diameter ranging from 200 nm to 5000 nm.

8. The contact lens-treating solution of claim 1, wherein said polyelectrolyte complex particulates in said contact lens-treating solution have a concentration ranging from 1×10⁻⁶ g/mL to 1×10⁻² g/mL.

9. The contact lens-treating solution of claim 1, wherein each of said polyelectrolyte complex particulates is prepared by adding a first aqueous solution containing said cationic polymer into a second aqueous solution containing said anionic polymer.

10. The contact lens-treating solution of claim 9, wherein said cationic polymer in said first aqueous solution has a concentration ranging from 0.0001 wt % to 3 wt %.

11. The contact lens-treating solution of claim 9, wherein said anionic polymer in said second aqueous solution has a concentration ranging from 0.0001 wt % to 5 wt %.

12. A method for treating a contact lens, comprising contacting a contact lens with a contact lens-treating solution containing water and polyelectrolyte complex particulates dispersed in said water, each of said polyelectrolyte complex particulates being formed of a cationic polymer and an anionic polymer.

13. The method of claim 12, wherein said polyelectrolyte complex particulates exhibit a zeta potential ranging from −80 mV to −28 mV in said contact lens-treating solution having a pH value ranging from 6 to 8.

14. The method of claim 12, wherein said cationic polymer is selected from the group consisting of chitosan, gelatin, polylysine, polyethyleneimine, polyacrylamide and combinations thereof.

15. The method of claim 12, wherein said anionic polymer is selected from the group consisting of poly-γ-glutamic acid, alginate, poly-L-glutamic acid, poly-L-glutamate, hyaluronic acid, alginic acid, chondroitin sulfate, dextran sulfate, pectin, polyaspartic acid, polyacrylic acid and combinations thereof.

16. The method of claim 12, wherein each of said cationic polymer and said anionic polymer has a weight-average molecular weight ranging from 80 kDa to 2000 kDa.

17. The method of claim 12, wherein each of said polyelectrolyte complex particulates is spherical in shape.

18. The method of claim 17, wherein said polyelectrolyte complex particulates have a particle diameter ranging from 200 nm to 5000 nm.

19. The method of claim 12, wherein said polyelectrolyte complex particulates in said contact lens-treating solution have a concentration ranging from 1×10⁻⁶ g/mL to 1×10⁻² g/mL.

20. The method of claim 12, wherein each of said polyelectrolyte complex particulates is prepared by adding a first aqueous solution containing said cationic polymer into a second aqueous solution containing said anionic polymer.

21. The method of claim 20, wherein said cationic polymer in said first aqueous solution has a concentration ranging from 0.0001 wt % to 3 wt %.

22. The method of claim 20, wherein said anionic polymer in said second aqueous solution has a concentration ranging from 0.0001 wt % to 5 wt %.

23. The method of claim 12, wherein said contact lens-treating solution further contains an additive selected from the group consisting of an antibacterial agent, a cleaning agent, a thickening agent, a chelating agent and combinations thereof.
